(19) United States
(12) Patent Application Publication
(10) Pub. No.: US 2026/0240141 A1
(43) Pub. Date: Aug. 20, 2026

(54) SYSTEM FOR AND METHOD OF DETECTING FOAMING IN SPRAYERS

(71) Applicant: DEERE & COMPANY, MOLINE, IL (US)

(72) Inventors: PRADEEP LOKARE, PUNE (IN); NATHMADHAV VITTHALRAO SHINDE, PUNE (IN); WILHELMUS PEETERS, OVERLOON (NL)

(21) Appl. No.: 19/531,991

(22) Filed: Feb. 6, 2026

(30) Foreign Application Priority Data
Feb. 20, 2025 (EP) 25159082.4

(51) Int. Cl. A01M 7/00

(52) U.S. Cl. CPC A01M 7/0089; A01M 7/0042

(57) ABSTRACT

An agricultural field sprayer includes a tank that receives and holds a liquid. The liquid includes an active ingredient dissolved in water. The agricultural field sprayer also includes an electronic camera that has a field of view directed towards a surface of the liquid in the tank and generates an image signal.

### CROSS-REFERENCE TO RELATED APPLICATION

This application claims the benefit of European Pat. App. No. 25159082.4, filed Feb. 20, 2025. The entire disclosure of the application referenced above is incorporated by reference.

### FIELD

The present disclosure relates to an agricultural field sprayer with a tank for receiving a liquid containing an active ingredient dissolved in water that may be subject to foaming.

### BACKGROUND

Agricultural distribution vehicles with a tank for a liquid product to be applied to an agricultural field, commonly referred to as field sprayers, are used to spread liquid products on a field. The distribution vehicles can be designed as self-propelled or towed vehicles or can be mounted detachably on a carrier vehicle (for example, an agricultural tractor). The distribution vehicles comprise a relatively wide distributor linkage that folds in for transport and on which nozzles are distributed across the width of to deliver the product. The products are usually liquids used to fertilize crops grown in the field or to control diseases or pests or weeds.

A possible problem with such field sprayers is foaming of the liquid product. Such foaming can occur during filling of the tank with the product or when the product is agitated (by pumping the product through nozzles into the tank or stirring the liquid within the tank to keep the concentration of active substances within the product homogenous) or when the tank is emptied. Foaming is a problem in particular when the tank is filled up to the top with a foam-problematic product and the latter runs out of the tank, since then the entire sprayer needs to be cleaned from the outside. Once foaming occurs, certain chemicals (foam stopper) can be applied to the tank to stop foaming.

Some details of field sprayers were described to avoid foaming of the product during filling of the tank (EP 0 405 244 A1, EP 0 472 860 A1), and reduction of agitation with decreasing tank fill state (DE 38 24 744 A1) to reduce or avoid foaming.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

An agricultural field sprayer includes a tank configured to receive and hold a liquid. The liquid includes an active ingredient dissolved in water. The agricultural field sprayer also includes an electronic camera configured to have a field of view directed towards a surface of the liquid in the tank and generate an image signal.

In other features, the agricultural field sprayer includes a user interface and a control unit (i) connected to the camera and the user interface and (ii) configured to send the image signal from the electronic camera to a display of the user interface.

In other features, the agricultural field sprayer includes a user interface and a control unit (i) connected to the camera and the user interface and (ii) configured to process the image signal from the electronic camera to detect foaming of the liquid in the tank.

In further features, the agricultural field sprayer includes a housing mounted in the tank and including a shutter. The electronic camera is partially surround by the housing and the shutter is movable between an open position in which the camera looks into the tank and a closed position in which the housing is sealed with respect to the tank.

In other features, the housing includes lighting configured to illuminate the interior of the tank.

In other features, the control unit is configured to activate the lighting in response to receiving an operator input via the user interface or detection of a foaming-susceptible situation by a controller.

In other features, the agricultural field sprayer includes an actuator configured to pivot the field of view of the electronic camera in at least one direction.

In other features, the control unit is configured to activate the actuator in response to receiving an operator input via the user interface or detection of a foaming-susceptible situation by a controller.

In other features, the electronic camera has a variable focal length.

In other features, the agricultural field sprayer includes an actuator configured to one change the variable focal length of the electronic camera. The control unit is configured to activate the actuator in response to receiving an operator input via the user interface or detection of a foaming-susceptible situation by a controller.

In other features, the agricultural field sprayer includes an actuator configured to one of move the shutter or pivot the field of view of the camera, The control unit is configured to activate the actuator in response to receiving an operator input via the user interface or detection of a foaming-susceptible situation by a controller.

In other features, the agricultural field sprayer includes a controller configured to activate, in response to receiving a signal from the control unit or in the user interface, measures against the foaming.

In other features, the measures against the foaming include at least one of controlling (i) a valve assembly for filling the liquid into the tank, (ii) an agitation propeller, or (iii) a valve or a pump connected to an agitation nozzle.

In other features, the measures against the foaming include providing instructions to an operator via the user interface to introduce an anti-foaming agent into the tank.

A method of detecting and mitigating foaming in a tank of an agricultural field sprayer, the method includes using a camera to view a surface of a liquid in the tank, generating a image of the surface of the liquid, analyzing the image signal to detect a foaming event, and deploying, in response to detecting a foaming event, an anti-foaming measure.

In further features, the anti-foaming measure includes at least one of controlling (i) a valve assembly for filling the liquid into the tank, (ii) an agitation propeller, or (iii) a valve or a pump connected to an agitation nozzle.

In other features, the anti-foaming measure includes providing instructions to an operator via a user interface to introduce an anti-foaming agent into the tank.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a schematical side view of a agricultural sprayer according to the principles of the present disclosure.

FIG. 2 is a schematic section through the tank of the sprayer of FIG. 1 along line 2-2.

In the drawings, reference numbers may be reused to identify similar and/or identical elements.

### DETAILED DESCRIPTION

As described, foaming can be problematic in field sprayers, but no method of detection of foaming is known in the art, other than an operator observing when product runs out of the tank; however, by that time the damage has already occurred. Foaming can also negatively influence the accuracy of the sensing of a tank fill state sensor. Foam detection by means of cameras was described in the context of bioreactors in which cells or microorganisms produce an antibody, a vaccine antigen, or other type of biopharmaceutical (see US Pat. App. No. 2021/0123101A1) and containers in which fermentation processes for brewing take place (see EP 1 243 644 A1), but not in the context of tanks of field sprayers.

An agricultural field sprayer includes a tank for receiving a liquid containing an active ingredient dissolved in water that may be subject to foaming. The tank includes an electronic camera with a field of view directed towards the surface of the liquid in the tank. The camera thus observes the surface of the liquid in the tank. In some implementations, an operator can view the image of the camera on a display and recognize foaming and, in response, apply appropriate measures. In other implementations, the foaming is detected automatically by an image processing system which alerts the operator and/or performs the appropriate measures automatically. This significantly reduces the risk that foaming has problematic consequences.

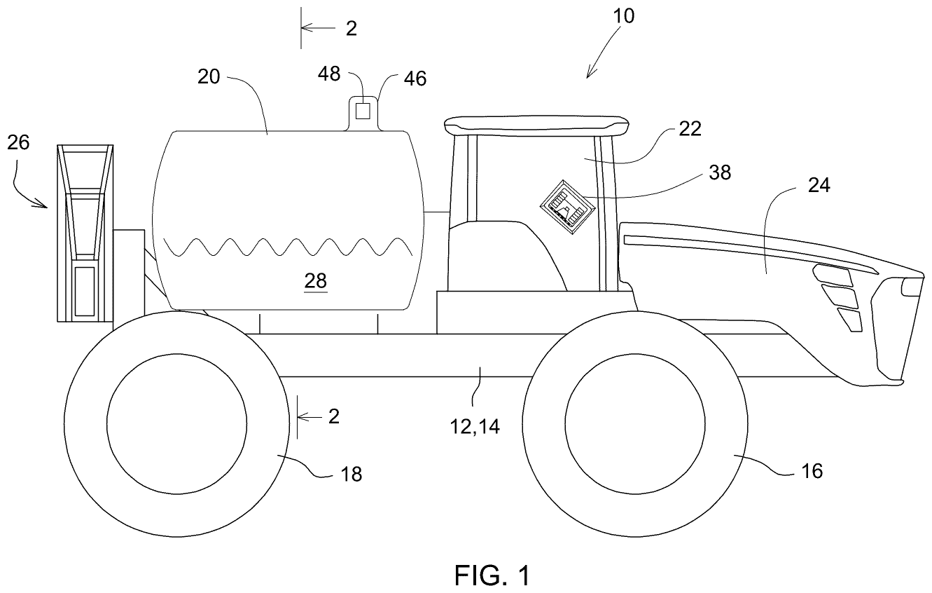

FIG. 1 shows a field sprayer 10 for the application of a liquid with an active ingredients. Although the field sprayer 10 is shown in the form of a self-propelled vehicle in FIG. 1, the field sprayer 10 could be in the form of a device attachable to a farm tractor or towed by it. The field sprayer 10 includes a chassis 12 with a frame 14 resting on the ground on front wheels 16 and rear wheels 18. The wheels 16, 18 may be steerable and/or driven. On the frame 14, a tank 20 for receiving a liquid 28 to be applied (for example, an active ingredient dissolved in water) and a cabin 22 behind an engine compartment 24 are supported. The usual direction of travel V in operation is directed to the right in FIG. 1. At the rear, an inclination and height-adjustable distribution linkage 26 is attached to the frame 14 of the distribution vehicle 10.

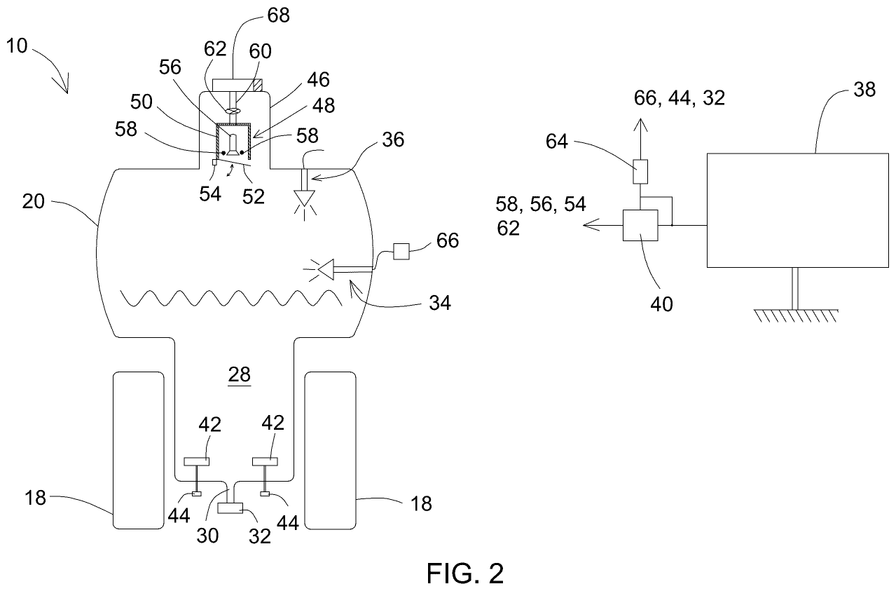

As shown in FIG. 2, the tank 20 includes an opening 30 at its bottom connected to a valve assembly 32. The valve assembly 32 is adapted to fill the tank 20 with the liquid 28 and to receive the liquid 28 from the tank 20 for supplying it to nozzles on the distribution linkage 26. In various implementations, filling of tank 20 can be performed though other openings—for example, at the top of tank 20. The tank 20 also includes a number of agitation nozzles 34, though which liquid 28 removed from tank 20 through bottom opening 30 can be reintroduced into tank 20 to keep the concentration of the active ingredient in tank 20 constant. The rate of liquid flowing through the agitation nozzles 36 is controlled by a valve 66. Agitation of liquid 28 is also possible by propellers 42 driven by motors 44. The tank 20 also includes rinsing nozzles 36 with which the interior of tank 20 can be cleaned after spraying.

At the cabin 22, a user interface 38 with a display and input means is provided, preferably in the form of a virtual terminal for a bus system according to ISO 11723, allowing the control of functions of the sprayer 10. A control unit 40 connects the user interface 38 to a camera system 48 located at the top of tank 20. In the implementation shown, the camera system 48 is inside a dome 46 at the upper side of the tank 20, supported on the underside of a removable lid 68 at the top of dome 46.

The camera system 48 comprises a housing 50 with a lower opening that can be closed with a shutter 52. The shutter 52 is operated by an actuator 54 adapted to move the shutter 52 between a closed position, in which the housing 50 is entirely sealed with respect to the tank 20, and an open position in which a camera 56 mounted inside housing 50 can view into the tank 20 and has a field of view directed towards the upper surface of the liquid 28. The housing 50 may also include illumination means (for example LEDs) 58 that illuminate the liquid 28. The housing 50 is connected to a holder 60 mounted at the top of dome 46 by an actuator 62 that can pivot housing 50 in the forward direction and/or the lateral direction to scan the surface of the liquid 28. In implementations where the camera 56 includes a super wide angle or fisheye lens, actuator 62 may be omitted. In some implementations, actuator 62 is within housing 50 instead of outside thereof.

The operator in cabin 22 can thus provide input into user interface 38 to start operation of the camera system 48. The operator will start camera operation in particular in situations when foaming of liquid can be expected or suspected. Such situations can be during filling of tank 20 or during a spraying operation or when the sprayer 10 drives over uneven terrain. These situations can also be detected automatically by a controller 64 that controls operation of the sprayer 10, for example at least one of automatic filling, spraying, agitation and rinsing, be it completely automatic or at least in part under operator control with the user interface 38 giving instructions to the operator and receiving confirmation that the instructions have been fulfilled.

Once operation of the camera system 48 starts, control unit 40 instructs actuator 54 to open shutter 52, to switch the illumination means 58 on and to start receiving image signals from an image sensor of camera 56. Control unit 40 or operator (via user interface 38) can also instruct actuator 62 to scan the surface of the liquid 28 in one or two dimensions and/or control a lens of camera 56 with variable focal length (zoom lens) to show interesting parts with an increased magnification ratio.

In one implementation, the image signals provided by camera 56 are displayed as image on the display of the user interface 38, be it unprocessed or processed for better perceptibility using image processing software of control unit 40, while the image can be shown on the entire display or a part thereof. This enables the operator to see if problems in tank 20 are arising and to take necessary measures, for example reducing the flow rate of liquid 28 into the tank 20 during filling or to introduce anti-foaming chemicals into the tank 20 or to decrease agitation by propellers 42 and/or agitation nozzles 36.

In another implementation, the image processing software running on control unit 40 is configured to detect foaming in tank 20 automatically by image processing, for example by detecting bubbles in the image. For this purpose, artificial intelligence can be used (neural network, deep learning etc.), or algorithms as described in US 2021/0123101 A1 or EP 1 243 644 A1, the entire disclosures of which are incorporated by reference. Once foaming is detected, a warning signal is given to operator via the user interface 38, be it optical or acoustic. The detected foam size and density can also be displayed to the operator.

In yet another implementation, once foaming has been detected by the image processing software in control unit 40, a corresponding signal is sent to controller 64, which then takes measures against the foaming, for example by controlling valve assembly 32, motors 44 and/or valve 66 (and/or a pump, not shown, providing the agitation liquid to nozzles 34) to reduce or stop the foaming. Alternatively, or additionally, the warning message can be given to operator via the user interface 38 (such that the operator can provide appropriate control input to the sprayer 10 via the user interface 38, as described above) and/or instructions, for example to introduce anti-foaming agent into tank 20, or the operator can input information to the user interface 38 that he sees foaming in the tank 20 and then the controller 64 performs said measures automatically and/or with operator support by displaying appropriate actions to be taken on the display of user interface 38.

The camera system 48 allows an operator or a control unit 40 to view inside the tank 20 and to see occurring foaming on a display or to detect foaming automatically. Thus, appropriate countermeasures can be applied instantaneously and larger problems—for example, liquid 28 pouring out of tank 20 and contaminating the sprayer 10 and the environment—can be avoided.

In various implementations, the user interface 38 is an integral part of the sprayer 10. In other implementations, the user interface 38 can be a mobile, preferably hand-held equipment like a laptop or tablet computer or a smartphone that receives signals from camera 56 preferably in a wireless manner using a suitable protocol. The control unit 40 would then be integrated into the user interface 38. The operator would in this case need to initiate the counter-measures on his end.

What is claimed is:

1. An agricultural field sprayer comprising:
a tank configured to receive and hold a liquid, wherein the liquid includes an active ingredient dissolved in water; and
an electronic camera configured to have a field of view directed towards a surface of the liquid in the tank and generate an image signal.

2. The agricultural field sprayer of claim 1, further comprising:
a user interface; and
a control unit (i) connected to the camera and the user interface and (ii) configured to send the image signal from the electronic camera to a display of the user interface.

3. The agricultural field sprayer of claim 1, further comprising:
a user interface; and
a control unit (i) connected to the camera and the user interface and (ii) configured to process the image signal from the electronic camera to detect foaming of the liquid in the tank.

4. The agricultural field sprayer of claim 3, further comprising:
a housing mounted in the tank and including a shutter,
wherein the electronic camera is partially surround by the housing and the shutter is movable between an open position in which the camera looks into the tank and a closed position in which the housing is sealed with respect to the tank.

5. The agricultural field sprayer of claim 4, wherein the housing includes lighting configured to illuminate the interior of the tank.

6. The agricultural field sprayer of one of claim 5, wherein the control unit is configured to activate the lighting in response to receiving an operator input via the user interface or detection of a foaming-susceptible situation by a controller.

7. The agricultural field sprayer of claim 4, further comprising an actuator configured to pivot the field of view of the electronic camera in at least one direction.

8. The agricultural field sprayer of claim 7, wherein the control unit is configured to activate the actuator in response to receiving an operator input via the user interface or detection of a foaming-susceptible situation by a controller.

9. The agricultural field sprayer of one of claim 4, wherein the electronic camera has a variable focal length.

10. The agricultural field sprayer of claim 9, further comprising an actuator configured to one change the variable focal length of the electronic camera,
wherein the control unit is configured to activate the actuator in response to receiving an operator input via the user interface or detection of a foaming-susceptible situation by a controller.

11. The agricultural field sprayer of claim 4, further comprising an actuator configured to one of move the shutter or pivot the field of view of the camera,
wherein the control unit is configured to activate the actuator in response to receiving an operator input via the user interface or detection of a foaming-susceptible situation by a controller.

12. The agricultural field sprayer of claim 3, further comprising a controller configured to activate, in response to receiving a signal from the control unit or in the user interface, measures against the foaming.

13. The agricultural field sprayer of claim 12, wherein the measures against the foaming include at least one of controlling (i) a valve assembly for filling the liquid into the tank, (ii) an agitation propeller, or (iii) a valve or a pump connected to an agitation nozzle.

14. The agricultural field sprayer of claim 12, wherein the measures against the foaming include providing instructions to an operator via the user interface to introduce an anti-foaming agent into the tank.

15. A method of detecting and mitigating foaming in a tank of an agricultural field sprayer, the method comprising:
using a camera to view a surface of a liquid in the tank;
generating a image of the surface of the liquid;
analyzing the image signal to detect a foaming event; and
deploying, in response to detecting a foaming event, an anti-foaming measure.

16. The method of detecting and mitigating foaming in a tank of an agricultural field sprayer of claim 15, wherein the anti-foaming measure includes at least one of controlling (i) a valve assembly for filling the liquid into the tank, (ii) an agitation propeller, or (iii) a valve or a pump connected to an agitation nozzle.

17. The method of detecting and mitigating foaming in a tank of an agricultural field sprayer of claim 15, wherein the anti-foaming measure includes providing instructions to an operator via a user interface to introduce an anti-foaming agent into the tank.
